(19) United States
(12) Patent Application Publication
(10) Pub. No.: US 2025/0109769 A1
(43) Pub. Date: Apr. 3, 2025

(54) SLIDABLE TILE AND TRACK SYSTEM

(71) Applicant: Mark Anthony Silveria, Columbia, MO (US)

(72) Inventor: Mark Anthony Silveria, Columbia, MO (US)

(21) Appl. No.: 18/898,888

(22) Filed: Sep. 27, 2024

Related U.S. Application Data
(60) Provisional application No. 63/586,774, filed on Sep. 29, 2023.

(51) Int. Cl. F16C 29/02; G09F 9/37

(52) U.S. Cl. CPC F16C 29/02; G09F 9/37

(57) ABSTRACT

A slidable tile and track system having a tile with one or more peripheral notches and a track having one or more track rails along which the tile rides there along. Each track rail extends in a longitudinal direction and co-planar but spaced apart from a supporting surface so that there is a gap between the track rail and the supporting surface. Each track rail having a distal rail protrusion extending therefrom and the rail protrusion dimensioned and shaped to form a locked engagement with each of the one or more peripheral notches, whereby the force of gravity by itself is insufficient to move the locked engagement to an unlocked engagement. Moreover, during the formation of the locked engagement, the track rail flexes into the gap and an audible click is produced when the biases track rail elastically snaps or flexes back into the peripheral notch.

### CROSS-REFERENCE TO RELATED APPLICATION

This application claims the benefit of priority of U.S. provisional application No. 63/586,774, filed 29 Sep. 2023, the contents of which are herein incorporated by reference.

### BACKGROUND OF THE INVENTION

The present invention relates to sliding charts and, more particularly, to a slidable tile and track system for a sliding chart.

For checkmark sheets or other displays where a user slides an object along a track from a first position to a second position, wherein the unoccupied first position reveals uncovered information, typically a round object is what is moved back and forth. However, round objects tend to not stay in place along a track when urged by the slightest external force or under the force of gravity when the track is titled. Even square or rectangular tiles, without perfect fitment, may unintentionally slide back to the first position (or to the second position when the desire is for the slidable object is to occupy the first position), if the track is tilted or even nudged, thereby frustrating the purpose of the slidable object to selective obscure or reveal information. Put another way, objects with geometric shapes resist formation of a locked engagement with the track, and so require perfect fitment with the track to resist unintentionally being dislodged from the position along the track the user desires. When standard round and rectangular tiles are used and the track is tilted, the standard tiles can move under the force of gravity. Moreover, if the fit is not perfect, standard round and rectangular tiles can bind in its track and will jam and not move.

As can be seen, there is a need for a slidable tile and track system for sliding charts and the like, whereby the system enables the selective formation of a locked engagement between the slidable tile and desired position along the track rails.

### SUMMARY OF THE INVENTION

The present invention allows a slidable tile to click into place and cover or reveal text, or to move an object, without a perfect fitment, yet does not allow the slidable tile to slide on its own. When embodied in slidable tiles, the present invention keeps circular, rectangular, and other geometrically shaped tiles secure in place so gravity will not move them, but they can be easily moved by a user's finger. The present invention does not require exact fitment or machining between tile and track, and so will not jam and work as designed even if manufacturing is not perfect.

The present invention embodies a slidable tile and track system wherein the slidable tiles have peripheral notches that selectively click into one of a plurality of “clicker” protrusions incorporated along the track. Each rail of the track may be connected to a perimetral frame, wherein each rail terminates in an inward/tile-facing bump or clicker protrusion dimensioned and shaped to nest into tile notches when the slidable tile is moved into place, forming a locked engagement with that rail.

The present invention allows sliding tiles to slide and satisfyingly ‘click’ into place, unmovable by gravity along, until moved by a person without requiring an exact fit or machining, preventing jamming while facilitating workability even if the system manufacturing is not perfect. As a result, the present invention can be used in sensory objects, toys, charts, books, and more.

In one aspect of the present invention, a slidable tile and track system providing the following: a tile having a body with a periphery; and one or more peripheral notches along the periphery; and a track having a perimetral frame defining a channel extending along a longitudinal direction; a track connector connected to the perimetral frame; for each track connector, at least one track rail extending from the track connector in the longitudinal direction and coplanar with the perimetral frame so that the at least one track rail is spaced apart from the perimetral frame so as to define a gap therebetween; and for each track rail, a rail protrusion extending therefrom into the channel, wherein the rail protrusion is dimensioned and shaped to form a locked engagement with each of the one or more peripheral notches, whereby the force of gravity by itself is insufficient to move the locked engagement to an unlocked engagement.

In another aspect of the present invention, wherein the slidable tile and track system further provides wherein for each peripheral notch, a transition between the periphery and the peripheral notch defines a point of tangency defines that causes formation of the locked engagement to produce an audible click sound, wherein the body of the tile is planar, wherein each peripheral notch is disposed along a longitudinal edge of the body of the tile, wherein the gap enables an associated track rail to flex into the gap during formation of the locked engagement, wherein each rail protrusion is disposed along a distal end of an associated track trail so as to maximize the flex into the gap during formation of the locked engagement, wherein for each track rail there is a complementary track rail disposed along an opposing longitudinal edge of the channel; further providing an extension extending in the longitudinal direction from an underside of the body of the tile for a distance that is at least equal to a longitudinal length of the body of the tile.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use.

FIG. 2 is an exploded perspective view of an exemplary embodiment of the present invention.

FIG. 3 is a top plan view of an exemplary embodiment of the present invention.

FIG. 4 is a top plan view of an exemplary embodiment of the present invention, illustrating lateral movement of a track rail and associated protrusion, thereby facilitating moving between a locked engagement and an unlocked engagement.

FIG. 5 is a top plan view of an exemplary embodiment of the present invention, illustrating lateral movement of a track rail and associated protrusion, thereby facilitating moving between a locked engagement and an unlocked engagement.

FIG. 6 is a perspective view of an exemplary embodiment of the present invention, illustrating how tiles can form locked engagements along different locations along the track of the system.

FIG. 7 is a perspective view of an exemplary embodiment of the present invention, illustrating how two or more different tracks (pairs of spaced apart parallel-oriented track rails) can be longitudinally aligned with a perimetral frame.

FIG. 8A is a perspective view of an exemplary embodiment of the present invention.

FIG. 8B is a top plan view of an exemplary embodiment of a tile of the present invention.

FIG. 8C is a top plan view of an exemplary embodiment of a track of the present invention, wherein each track rail 37 has its own track connector 35.

FIG. 9A is a perspective view of an exemplary embodiment of the present invention, illustrating an extension 46 attached to the tile 9 that can move as the tile 9 moves.

FIG. 9B is a perspective view of an exemplary embodiment of the present invention.

FIG. 9C is a top plan view of an exemplary embodiment of the present invention.

FIG. 9D is a top plan view of an exemplary embodiment of the present invention.

FIG. 10 is a top plan view of an exemplary embodiment of the present invention shown in use, illustrating a tile 50 occupying a first position so that the attendant extension 46 reveals an underlying color of an associated design cutout 60, and another tile 52 occupying a second position so that its extension 46 effectuates a color change for (by way of the color of the extension 46 that is covering) its associated design cutout 62, and yet another tile 54 transitioning between the first position and the second position so that its extension 46 is transitioning the associated design cutout 64 from the underlying color to the color of the extension, wherein the cutouts 60, 62, 64 are formed in the cover 48.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

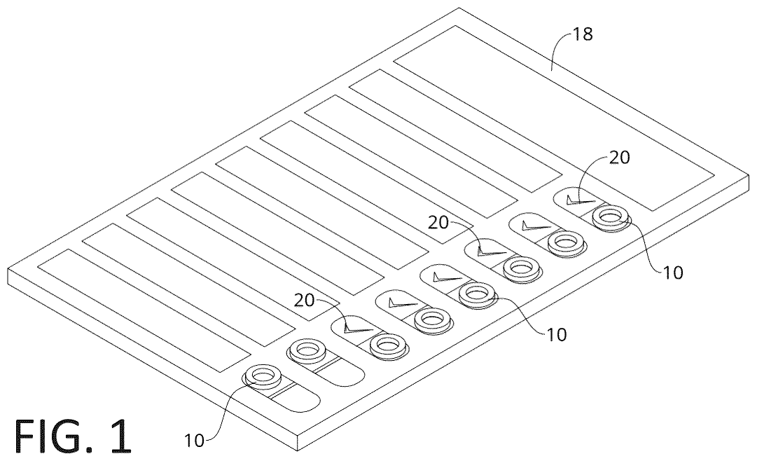

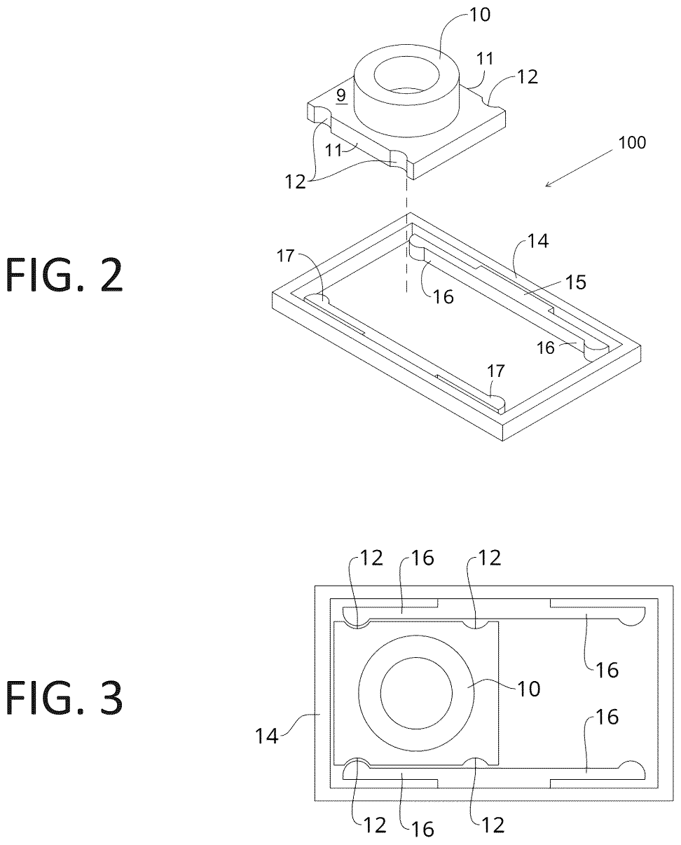

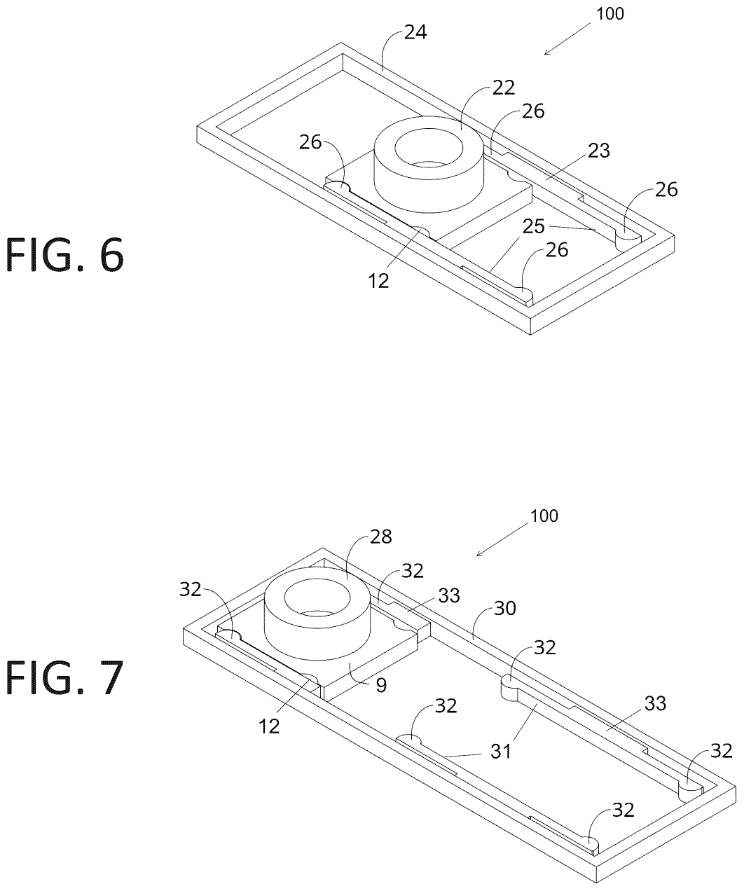

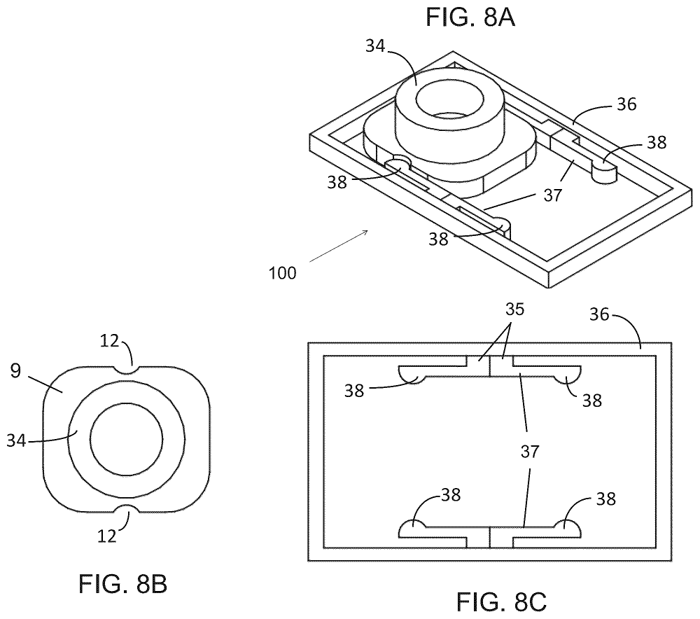

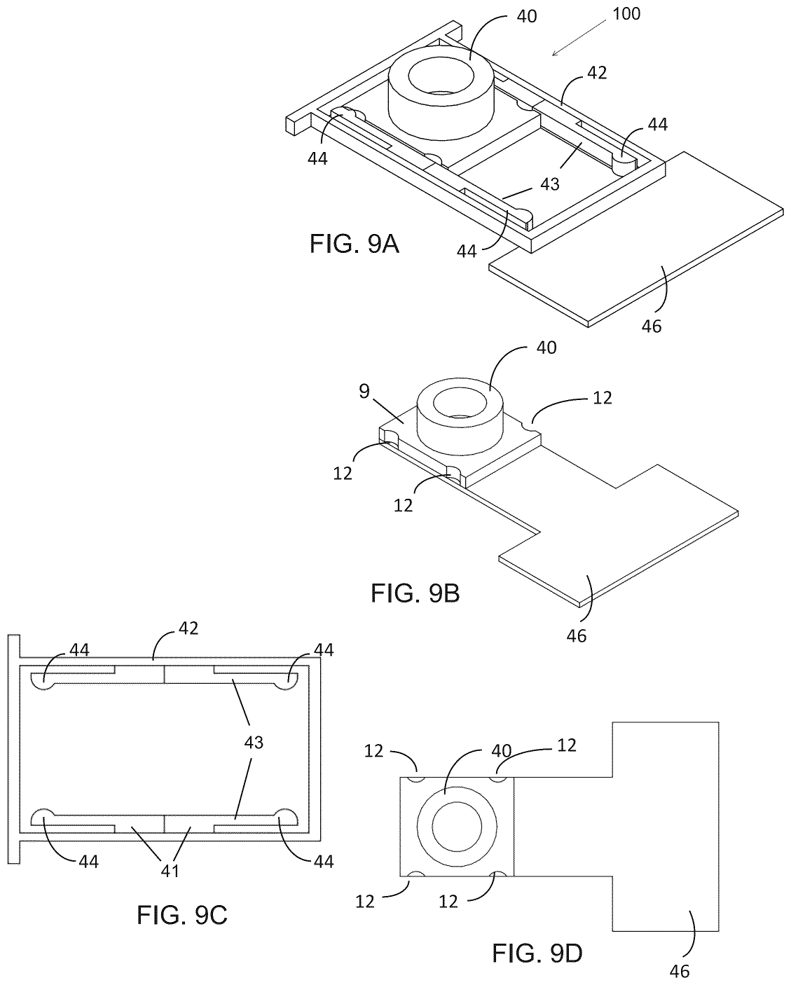

Referring to FIGS. 1 through 10, the present invention may include a slidable tile and track system 100 embodying slidable tile 9 that operatively associates with track 16, 25, 31, 37, and 43, respectively, to ride along the respective track defined by pairs of spaced-apart parallel-oriented track rails 16, 25, 31, 37, and 43.

Each track rail 16, 25, 31, 37, and 43 may be connected, by way of a track connector 15, 23, 33, 35, and 41, respectively, to a perimetral frame 14, 24, 30, 36, and 42, respectively, so that the perimetral frame 14, 24, 30, 36, and 42 circumscribes the respective track system 100. Each track rail 16, 25, 31, 37, and 43 and respective perimetral frames 14, 24, 30, 36, and 42 may share a longitudinal axis, which in turn defines a longitudinal direction in which the respective slidable tile 9 slides along an operatively associated track rails 16, 25, 31, 37, and 43.

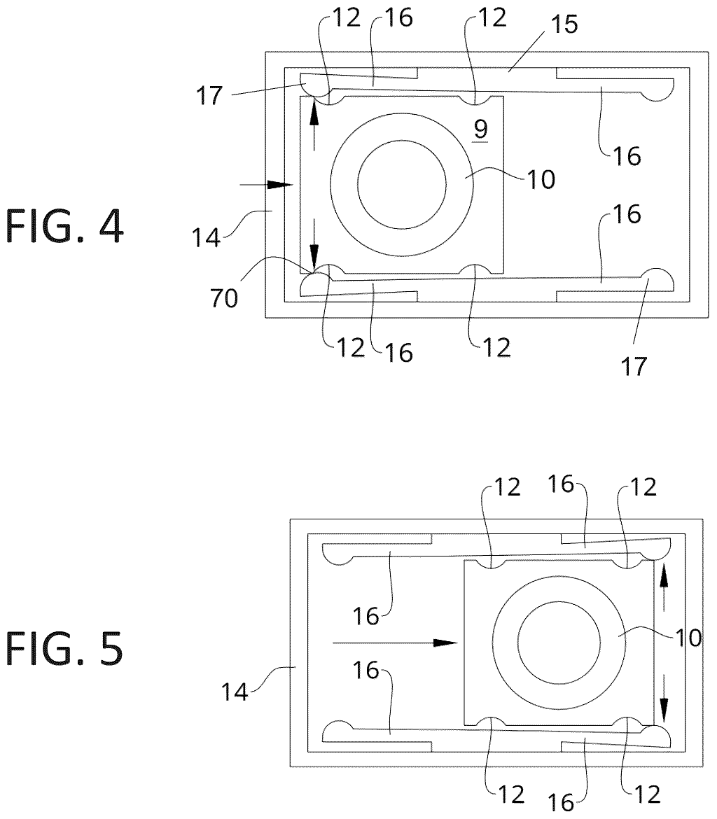

Each tile 9 has a planar body defined by a peripheral edge 11, wherein at lease one peripheral edge 11 provides at least one peripheral notch 12. Each track rail 16, 25, 31, 37, and 43 extends from its respective track connector 15, 23, 33, 35, and 41 in the longitudinal direction, so that each track rail 16, 25, 31, 37, and 43 is spaced apart from its respective perimetral frame 14, 24, 30, 36, and 42 (or whatever object the track connector connects the track rail to). This spacing or gap between the track rail and the perimetral frame allows for some ‘give’ in the track rail, which essentially is cantilevering from its track connector, so that the distal end of the track rail can move laterally (generally orthogonal or transverse the longitudinal direction, as seen in FIGS. 4 and 5) toward its respective perimetral frame. This gap is critical because at the distal end of each track rail 16, 25, 31, 37, and 43 is a rail protrusion 17, 26, 32, 38, and 44 dimensioned and shaped to nest into a peripheral notch 12 of a tile 9 that slides over it while riding along the associated track rails 16, 25, 31, 37, and 43. Because of the abrupt transition from the linear peripheral edge 11 to the, in some embodiments, semi-circular peripheral notch 12—referred here as the point of tangency 70—when a rounded rail protrusion 17, 26, 32, 38, and 44 nests into said peripheral notch 12 a ‘click’ sound is produced, indicating the formation of a locked engagement between the peripheral notch 12 and the protrusion The complementary rounded shapes of the peripheral notch 12 and the rail protrusion enables a user to move from locked engagement to an unlocked engagement through applying an external force by way of their finger or object, whereby the rail protrusion becomes un-nested from the peripheral notch 12. Accordingly, each tile is selectively movable between the locked engagement and the unlocked engagement so that the tile rides between two track rails in the longitudinal direction when desired by the user. The locked engagement is adapted so that tilting or pitching of the track rails will not unlock the locked engagement under the force of gravity alone.

There are many shapes that the slidable tile can be, but the most basic shape is a semi-flat rectangular shape, oval or any geometric or non-geometric shape as long as they are rideable along one or two track rails and allow for the locked engagement between the peripheral notch and rail protrusion. Likewise, the peripheral notch and rail protrusion can have other complementary (geometric or non-geometric) shapes if they enable the finger-powered transition between the locked engagement and the unlocked engagement.

The gap between the track rail and the perimetral frame enables flex, thereby allowing the track rail to move laterally if longitudinal force is applied to the operatively associated tile because of the interaction of the tile and the wedge-like transition presented by the protrusions, causing the rail protrusion to release (or click into place depending on how the user is pushing the tile). So, the tile can be locked into one position, and then a person can apply force to slide the tile/button sideways and allow it to leave the position and lock into another position giving a satisfying ‘click’ sensation when doing so.

It should be understood that the perimetral frame 14, 24, 30, 36, and 42 need not be part of the slidable tile and track system 100, as long as the track connectors 15, 23, 33, 35, and 41 connect to an object so that the track rails 16, 25, 31, 37, and 43 are spaced apart from said object to enable their critical flexibility or give.

The rail protrusion can accommodate any number of tiles as the track rails can be repeated or space apart. For example, the system can provide a row or column of buttons each with their own track rails. The track rails can also be made to be parallel to the track or perpendicular to the track with a more flexible material.

In the context of a sliding chart or task managing device 18, one or more slidable tile and track system 100 can be integrated thereto so that a user of the task managing device 18 can move the slidable tile 9 along the track portion, revealing or covering an indicia area 20 along the task managing device 18. Indicia area 20 may display a check mark (or any other indicative information) to facilitate the purpose of the sliding chart or task managing device 18.

The present invention can be made by almost any manufacturing process-e.g., three-dimensionally (3D) printed from a stereolithography (STL) file, cut on a computer numerical control (CNC) machine, injection molded, or any other means if the resulting slidable tile and track system 100 functions as disclosed herein.

The slidable tile and track system 100 can be expanded to accommodate any number of layouts beyond a sliding chart as the slidable tiles can be modified to a myriad of shapes. Any customizable object 10, 22, 28, 34, and 40 can also be placed on top of tile 9 (for example a round circle on top of the rectangular base, or a 3D shape image such as a heart or other icon on top of the body of the tile 9). The rectangular base/body, as mentioned above, of the tile 9 can be other shapes such as an oval, hexagon, and the like, that allow the same sliding manner.

There can be more than two positions for the slidable tile, and the track layout can also change to accommodate more than one slidable tile. The rail protrusion can be made to only support one tile or many. The tile base/body can be changed to another shape that can move in the track. The tile can be used to move text or an image, or any other object floating on the sliding tile, from one position to another in the track rather than covering or uncovering something behind it.

The peripheral notches or grooves can be made in many different shapes and can occur on the tile in any quantity. The tile can be made with one or more notches depending on the shape of the tile or the protrusion design. For example, a rectangular tile can have one notch in each corner, or an oval tile can have one notch on each side. A rectangular shape on a track can also just have a single notch and work with a single-track rail.

Most commonly the present invention is used as an internal part on top of some kind of base, that has a cutout for the tile and track, and behind a cover 48 of some sort that covers the track rails but allows the button to function. This base and cover 48 “sandwich” the tile and track rail keeping them in place and covering the workings of the present invention. The cover is the most common use but may not be necessary if the track rail is fixed to the base or the tile is fixed to a separate track in the base.

Any indicia area 20 to cover or uncover (such as a check mark or an ‘X’) can reside in a cutout along a flat surface deep enough to accommodate the slidable tile and track system 100. For instance, a manufacturer may provide printed text or image in the indicia area 20 of the cutout. The manufacturer can then put the slidable tile and track system 100 over the indicia area 20 and have a complementary customizable object 10, 22, 28, 34, or 40 on the tile 9 of the slidable tile and track system 100. The manufacturer can then fix something that covers the top so the slidable tile and track system 100, sandwiching it between some kind of cover 48. For example, a top cover 48 that has a cylindrical hole in it so a person can move the tile side to side but the top cover 48 overlays on top of a portion of the slidable tile and track system 100 so that the tile and the track rails will not fall out of the device.

If one has a three-dimensional object that is desirous to move along a track and has fixed positions it should stay in along the way, the present invention is applicable. A manufacturer can make a track rail with enough arms/rails and length to accommodate each position desired and put the tile in the track: fix a customizable object to the upper surface of the tile. Put the slidable tile and track system 100 and apply a top cover 48 over the top.

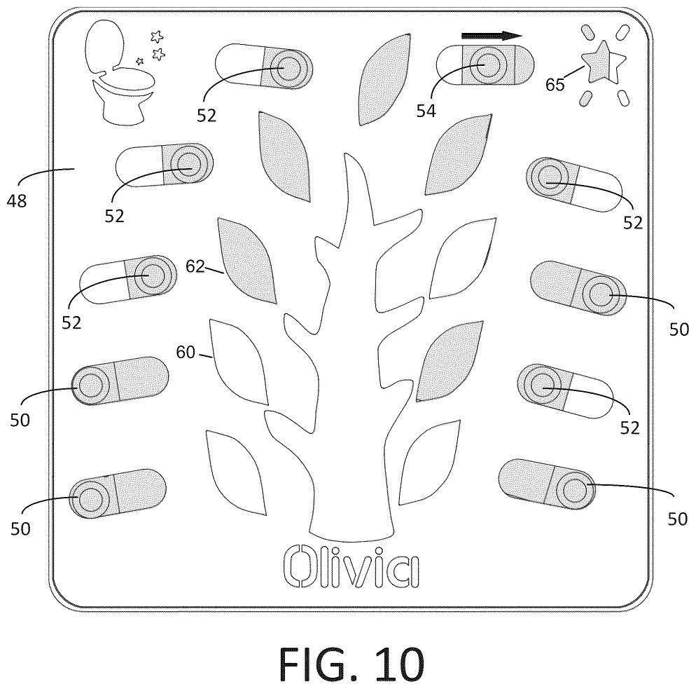

Referring to FIG. 10, in one embodiment, a chart or book or other kind of toy where one has a cutout shape 60, 62, 65 that a user desires to change colors or appearance by moving a tile, the present invention is applicable. Here one would make the slidable tile and track system 100 and, as part of the cover 48, create a cutout shape 60, 62, or 65 in a first appearance/color and have an attendant extension 46 of a second appearance connected to the tile. Place the slidable tile and track system 100 in some kind of base object and put a cover 48 over the slidable tile and track system 100. The cover 48 should have some kind of cutout opening 60, 62, and/or 65 where an appearance change is desired, and it needs to allow the tile to function properly. The slidable tile and track system 100 should be behind the cover 48 in such a way that when one moves the tile it moves the shape or design fixed to it to be visible in the opening in the cover or not visible.

Additionally, the present invention can be used in kids toys for checking off tasks. It can be used in adult lists for checking tasks. It can be used an any kind of toy where an item needs to move from one position to another and stay fixed after it moves. It can be used to cover or uncover something with a different shape attached to the button. It can be used to move a shape along a track. It can be used to reveal information or designs with the slide of a button. It can be used in any item displaying information or item that needs a slidable button that needs the button to stay in place after being put into position.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A slidable tile and track system, the system comprising:
a tile comprising:
a body with a periphery; and
one or more peripheral notches along the periphery; and
a track comprising:
a perimetral frame defining a channel extending along a longitudinal direction;
a track connector connected to the perimetral frame;
for each track connector, at least one track rail extending from the track connector in the longitudinal direction and coplanar with the perimetral frame so that the at least one track rail is spaced apart from the perimetral frame so as to define a gap therebetween; and
for each track rail, a rail protrusion extending therefrom into the channel, wherein the rail protrusion is dimensioned and shaped to form a locked engagement with each of the one or more peripheral notches, whereby the force of gravity by itself is insufficient to move the locked engagement to an unlocked engagement.

2. The system of claim 1, wherein for each peripheral notch, a transition between the periphery and the peripheral notch defines a point of tangency defines that causes formation of the locked engagement to produce an audible click sound.

3. The system of claim 1, wherein the body of the tile is planar.

4. The system of claim 1, wherein each peripheral notch is disposed along a longitudinal edge of the body of the tile.

5. The system of claim 1, wherein the gap enables an associated track rail to flex into the gap during formation of the locked engagement.

6. The system of claim 5, wherein each rail protrusion is disposed along a distal end of an associated track trail so as to maximize the flex into the gap during formation of the locked engagement.

7. The system of claim 1, wherein for each track rail there is a complementary track rail disposed along an opposing longitudinal edge of the channel.

8. The system of claim 1, further comprising an extension extending in the longitudinal direction from an underside of the body of the tile for a distance that is at least equal to a longitudinal length of the body of the tile.

9. A slidable tile and track system, the system comprising:
a tile comprising:
a planar body with a periphery; and
one or more peripheral notches along the periphery; and
a track comprising:
a perimetral frame defining a channel extending along a longitudinal direction;
a track connector connected to the perimetral frame;
for each track connector, at least one track rail extending from the track connector in the longitudinal direction and coplanar with the perimetral frame so that the at least one track rail is spaced apart from the perimetral frame so as to define a gap therebetween; and
for each track rail, a rail protrusion extending therefrom into the channel, wherein the rail protrusion is dimensioned and shaped to form a locked engagement with each of the one or more peripheral notches, whereby the force of gravity by itself is insufficient to move the locked engagement to an unlocked engagement, wherein for each peripheral notch, a transition between the periphery and the peripheral notch defines a point of tangency defines that causes formation of the locked engagement to produce an audible click sound, wherein each peripheral notch is disposed along a longitudinal edge of the body of the tile, wherein the gap enables an associated track rail to flex into the gap during formation of the locked engagement, wherein each rail protrusion is disposed along a distal end of an associated track trail so as to maximize the flex into the gap during formation of the locked engagement, and wherein for each track rail there is a complementary track rail disposed along an opposing longitudinal edge of the channel.
